(19) United States
(12) Patent Application Publication
(10) Pub. No.: US 2009/0294623 A1
(43) Pub. Date: Dec. 3, 2009

(54) System, Method and Apparatus for Attaching Items to a Wall

(76) Inventor: Bryan Pinchuk, Miami, FL (US)

Correspondence Address: GORDON & JACOBSON, P.C., 60 LONG RIDGE ROAD, SUITE 407, STAMFORD, CT, 06902, US

(21) Appl. No.: 12/473,884

(22) Filed: May 28, 2009

Related U.S. Application Data
(60) Provisional application No. 61/056,646, filed on May 28, 2008.

(51) Int. Cl. F16M 13/00

(52) U.S. Cl. 248/546

(57) ABSTRACT

A tool-less system for securing items to a wall or other support structure includes a first part and a second part. The first part includes an elongate hand-holdable plate with a rear portion extending rearward from said plate. The rear portion has a helical threaded interface for screwing into the wall or other support structure by hand manipulation of the plate. The second part includes a support portion and a rear-facing track. The support portion mechanically supports at least one article during use. The track has a slot for receiving the plate of the first part and a narrow opening extending lengthwise along the slot to allow passage of the rear portion of the first part therethrough during use. Hand manipulation is used to secure the first part to the wall, and the first part is used as an anchor to mechanically support the second part as the track slidably receives the elongate plate of first part.

In another aspect, a tool-less device for securing an article to a wall or other support structure includes an elongate hand-holdable body and a rear portion extending rearward from the body. The rear portion has a helical threaded interface for screwing into the wall or other support structure by hand manipulation of the body. A support portion extends from the body and functions to mechanically support at least one article during use.

### CROSS-REFERENCE TO RELATED APPLICATIONS

This application claims benefits from U.S. Provisional Patent Application No. 61/056,646, filed May 28, 2008, the contents of which are hereby incorporated herein by reference.

### BACKGROUND OF THE INVENTION

1. Field of the Invention

This invention relates to mechanisms for hanging articles on a wall or other vertical support surfaces.

2. State of the Art

Articles are often supported on a wall or other support structure by shelves or hooks that are mounted to the support structure by screws or similar fasteners that require a screwdriver or a drill to fasten the screws into the support structure. It is difficult for some people to use a drill or a screwdriver. Moreover, in some applications, using a drill or screwdriver is cumbersome, or a drill or screwdriver is not readily available for use.

### SUMMARY OF THE INVENTION

It is therefore an object of the invention to provide a system for securing items to a wall or other support structure that is installed without the need for screwdriver or a drill or other tool.

It is another object of the invention to provide such a system that can be adapted to support different articles.

It is a further object of the invention to provide such a system that can be adapted for different applications, such as securing shelving to a wall and/or securing hooks to a wall.

In accord with these objects, which will be discussed in detail below, a system for securing items to a wall or other support structure includes a first part and a second part. The first part includes an elongate hand-holdable plate with a rear portion extending rearward from said plate. The rear portion has a helical threaded interface for screwing into the wall or other support structure by hand manipulation of the plate. The second part includes a support portion and a rear-facing track. The support portion mechanically supporting at least one article during use. The track having a slot for receiving the plate of the first part and a narrow opening extending lengthwise along the slot to allow passage of the rear portion of the first part therethrough during use. Hand manipulation is used to secure the first part to the wall, and the first part is used as an anchor to mechanically support the second part as the track slidably receives the elongate plate of first part.

It will be appreciated that the system allows for installation without the need for screwdriver or a drill or other tool.

According to one embodiment of the invention, a platform for supporting a shelf.

According to another embodiment of the invention, the support portion of the second part includes at least one hook.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective rear view of a fixation member in accordance with the present invention.

FIG. 2A is a side view of a shelf support member that is secured to a wall or other support structure by the fixation member of FIG. 1 in accordance with the present invention.

FIG. 2B is a bottom perspective view of the shelf support member of FIG. 2A.

FIG. 3A is a perspective front view of a hook member that is secured to a wall or other support structure by the fixation member of FIG. 1 in accordance with the present invention.

FIG. 3B is a perspective bottom view of the hook member of FIG. 3A.

FIG. 3C is a perspective rear view of the hook member of FIG. 3A.

FIG. 4A is a perspective front view of a double-hook member that is secured to a wall or other support structure by the fixation member of FIG. 1 in accordance with the present invention.

FIG. 4B is a perspective bottom view of the double-hook member of FIG. 4A.

FIG. 4C is a perspective rear view of the double-hook member of FIG. 4A.

### DETAILED DESCRIPTION OF THE PREFERRED EMBODIMENTS

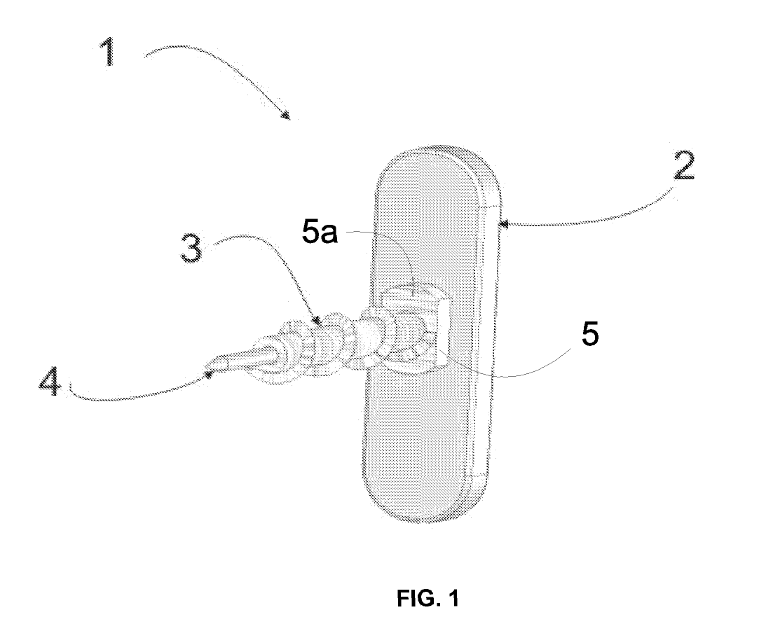

Turning now to FIG. 1, a fixation member 1 in accordance with the present invention includes an elongate plate 2 with a boss 5 projecting from the rear side of the plate 2 and a helical screw interface 3 extending rearward from the boss 5 to an elongated tip 4. The interface 3 employs a course helical thread that allows easy installation into drywall or plasterboard of a wall or other support structure by hand rotation of the plate 2. The boss 5 includes a planar rear-facing surface 5a that is intended to lie flush to the wall or other support structure during use. In the preferred embodiment, the fixation member 1 is realized by course helical threaded screw (3) that is welded (or otherwise fixed) to an elongate rigid metal plate (2). The head of the screw forms the boss 5 of the fixation member 1. Alternatively, the fixation member 1 can be realized as a unitary article of molded rigid plastic. Alternatively, metal portions (e.g., metal supports or metal screws) can be integral with rigid plastic portions, for example by insert molding and the like.

The fixation member 1 functions as a tool-less device whereby the plate 2 in held in the user's hand, and hand manipulation is used to insert the elongated tip 4 of the screw interface 3 into the wall and rotate the plate 2 in order to screw interface 3 into the wall. When in place, the rear-facing surface 5a of the boss 5 is intended to lie flush against the wall and the elongate plate 3 is offset from the wall by the thickness of the boss 5. In this configuration, the elongate plate 3 can be used as an anchor to hold up different devices, such as a shelf support member or hook member as described herein.

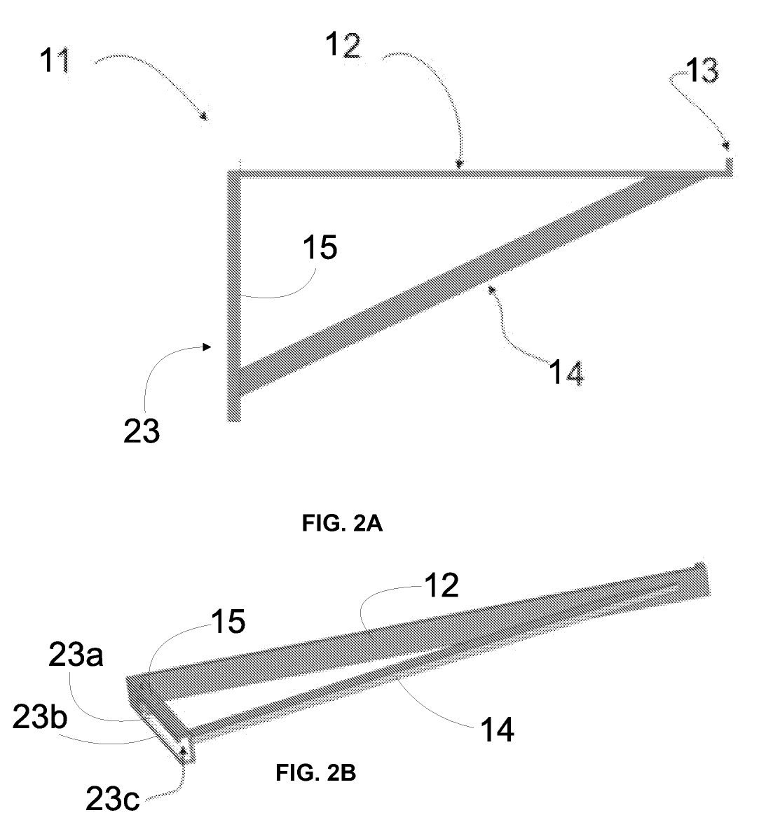

FIGS. 2A and 2B illustrate a shelf support member 11 that is secured to a wall or other support structure by the fixation member 1 of FIG. 1. The shelf support member 11 has a platform 12 on which a shelf (not shown) rests when in place. The front end of the platform 12 preferably includes a lip 13 that aids in minimizing forward movement of the shelf when installed. The shelf support member 11 also includes a rear support 15 that extends downward from the rear end of the platform 12 and a truss support 14 that extends at an angle between the bottom part of the rear support 15 and the platform 12 to allow for additional support. The shelf support member 11 is anchored to the fixation member 1 of FIG. 1 by means of rear-facing track 23 that is an integral part of the rear support 15. The track 23 includes a slot 23a with a rear-facing fillet 23b that extends lengthwise along the slot 23a. The slot 23a is accessible from a bottom-facing opening 23c that receives the plate 3. The plate 3 is slidable within the slot 23a. The fillet 23b allows for passage of the boss 5 therethrough during insertion of the plate 3 into the slot 23a. In the preferred embodiment, the thickness of the rear-facing wall of the slot 23a corresponds to the thickness of the boss 5. In this configuration, the rear-facing wall of the 23a lies flush against the wall when installed, which can aid in minimizing unwanted movement of the shelf support member 11 in the installed configuration. In the preferred embodiment, the shelf support member 11 is realized by a unitary article of molded rigid plastic. Alternatively, metal portions (e.g., metal supports) can be integral with rigid plastic portions, for example by insert molding and the like.

During use, fixation member 1 is secured to a wall or other support surface as described above, and the plate 3 of the fixation member 1 is inserted into the track 23 of the shelf support member 11. In this configuration, the walls of the slot 23a surround and engage the plate 3 and the plate 3 anchors the shelf support member 11 to the wall. Advantageously, the shelf support member 11 covers and hides the fixation member 1 from view during use. Two or more shelf support members 11 are secured to the wall in this manner and used to support a shelf (not shown) that lies on the platform 12 of the respective support members 11.

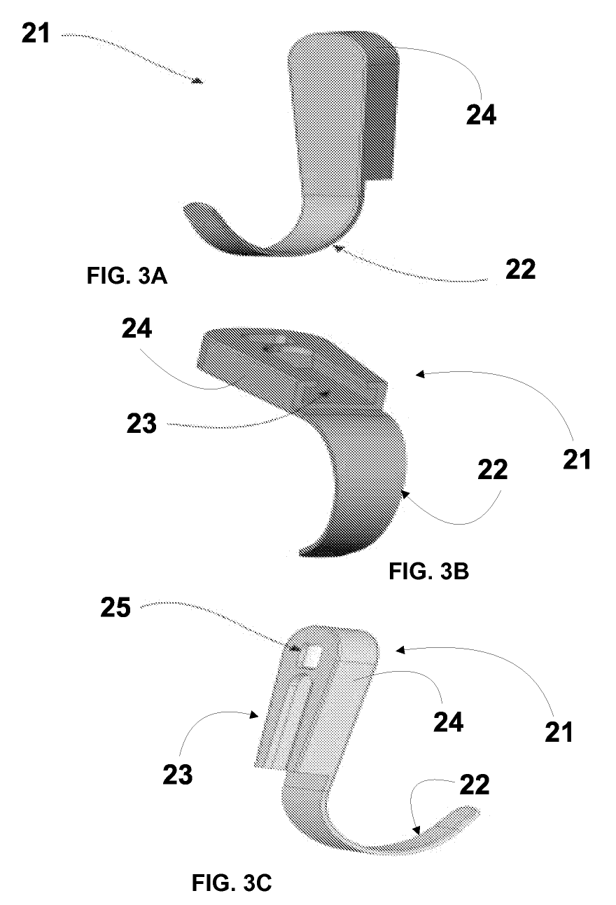

FIGS. 3A, 3B and 3C illustrate a hook member 21 that is secured to a wall or other support structure by the fixation member 1 of FIG. 1. The hook member 21 includes a head portion 24 with a support hook 22 extending therefrom suitable for hanging a towel, robe, shirt, pants, purses, bags, or other articles thereon. The hook member 21 is anchored to the fixation member 1 of FIG. 1 by means of a rear-facing track 23 that is an integral part of the head portion 24 as shown. The structure of the track 23 is described above with respect to the shelf support member 11.

During use, fixation member 1 is secured to a wall or other support surface as described above, and the plate 3 of the fixation member 1 is inserted into the track 23 of the hook member 21. In this configuration, the walls of the slot 23a surround and engage the plate 3 and the plate 3 anchors the hook member 21 to the wall. Advantageously, the hook member 21 covers and hides the fixation member 1 from view during use. Two or more hook members 21 can be secured to the wall in this manner and used to support multiple articles.

The track 23 of hook member 21 can include a magnet 25 that is magnetically coupled to metal of the plate 3 when the plate 3 is positioned inside the track 23. In this configuration, the magnetic attraction between the magnet 25 and the plate 3 aids in maintaining the plate 3 inside the track 23 during use. Other retention means, such as interlocking snap-fit detents or other suitable elements that are part of the track 23 and/or plate 3, can be used for maintaining the plate 3 inside the track 23 during use.

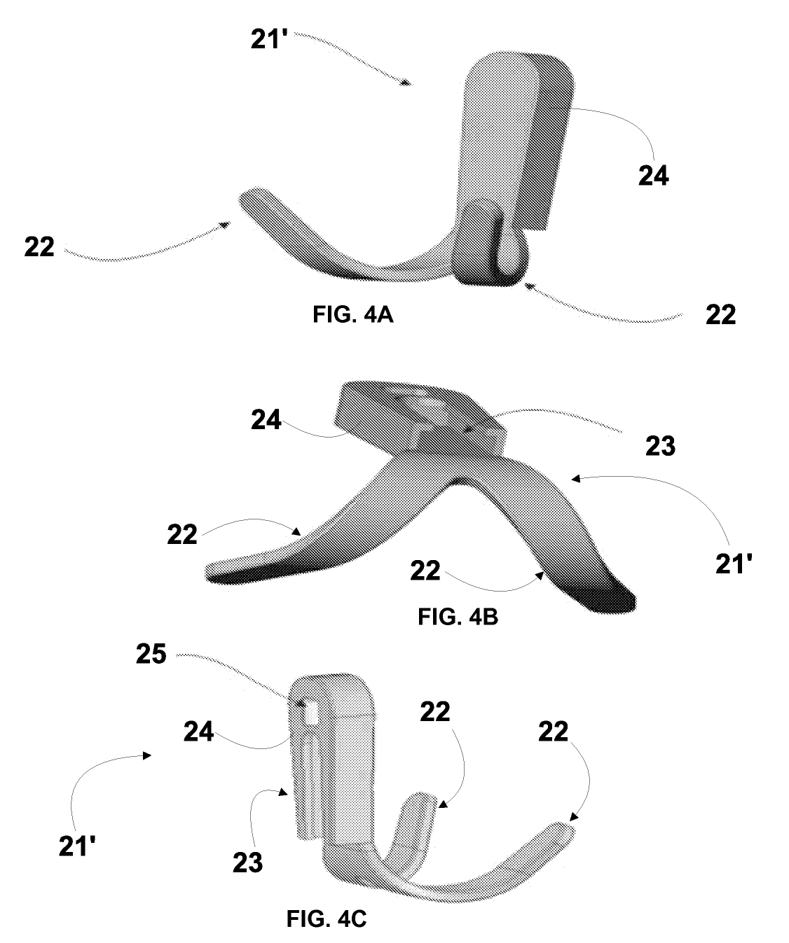

FIGS. 4A, 4B and 4C illustrate a double-hook member 21′ that is secured to a wall or other support structure by the fixation member 1 of FIG. 1. The double-hook member 21′ includes a head portion 24 with two support hook 22 extending therefrom suitable for hanging a towel, robe, shirt, pants, purses, bags, or other articles thereon. The double-hook member 21′ is anchored to the fixation member 1 of FIG. 1 by means of rear-facing track 23 that is an integral part of the head portion 24 as shown. The structure of the track 23 is described above with respect to the shelf support member 11.

During use, fixation member 1 is secured to a wall or other support surface as described above, and the plate 3 of the fixation member 1 is inserted into the track 23 of the double-hook member 21′. In this configuration, the walls of the slot 23a surround and engage the plate 3 and the plate 3 anchors the double-hook member 21′ to the wall. Advantageously, the hook member 21′ covers and hides the fixation member 1 from view during use. Two or more double-hook members 21′ can be secured to the wall in this manner and used to support multiple articles.

The track 23 of double-hook member 21′ can include a magnet 25 that is magnetically coupled to metal of the plate 3 when the plate 3 is positioned inside the track 23. In this configuration, the magnetic attraction between the magnet 25 and the plate 3 aids in maintaining the plate 3 inside the track 23 during use. Other retention means, such as interlocking snap-fit detents or other suitable elements that are part of the track 23 and/or plate 3, can be used for maintaining the plate 3 inside the track 23 during use.

Advantageously, the system of the present invention provides a system for securing items to a wall or other support structure that is installed without the need for screwdriver or a drill or other tool. Instead, hand manipulation is used to secure the fixation member of the present invention to the wall, and the fixation member is used as an anchor to mechanically support a support member with a track that slidably receives the elongate plate of the fixation member.

In alternate embodiments, a kit can be assembled that includes the following:

one or more fixation members 1 as described herein;

a plurality of shelf support members 1 1 as described herein; and/or

a plurality of hook members 21 and/or 21′ as described herein; and/or

a plurality of other support members with a track that slides over the elongate plate of the fixation member 1 as described herein.

In an alternative embodiment, the fixation member 1 can be adapted to include a support hook similar to the hook member 21 (or double support hook similar to the double hook member 21′ or some other suitable article support structure) and used as a tool-less device for supporting articles on a wall or other support structure.

There have been described and illustrated herein several embodiments of a system for securing one or more articles to a wall or other support structure and a method of operating same. While particular embodiments of the invention have been described, it is not intended that the invention be limited thereto, as it is intended that the invention be as broad in scope as the art will allow and that the specification be read likewise. Thus, while particular configurations of a fixation member that can be screwed into a wall by hand manipulation have been disclosed, it will be appreciated that other configurations for the fixation member as well. In addition, while particular types of support members have been disclosed, it will be understood that other types of support members that include a slotted rear-facing track can be used in conjunction with the fixation member of the present invention. Also, while preferred materials and manufacturing aspects of the system and apparatus of the present invention have been disclosed, it will be recognized that other materials and manufacturing aspects can be used as well. It will therefore be appreciated by those skilled in the art that yet other modifications could be made to the provided invention without deviating from its spirit and scope as claimed.

What is claimed is:

1. A system for securing an article to a wall or other support structure, the system comprising:
a first part comprising an elongate hand-holdable plate with a rear portion extending rearward from said plate, said rear portion having a helical threaded interface for screwing into the wall or other support structure by hand manipulation of said plate;
a second part comprising a support portion and a rear-facing track, said support portion for mechanically supporting at least one article during use, and said track having a slot for receiving said plate of said first part and a narrow opening extending lengthwise along said slot to allow passage of said rear portion of said first part therethrough during use.

2. A system according to claim 1, wherein:
said rear portion includes a boss projecting from said plate, said boss providing clearance between the wall or other support structure and said plate for insertion of said plate into said slot.

3. A system according to claim 1, wherein:
said track includes an opening into said slot that receives said plate into said slot from below said track during use.

4. A system according to claim 1, wherein:
said support portion of said second part comprises a platform for supporting a shelf.

5. A system according to claim 4, wherein:
said platform has a lip at its front end.

6. A system according to claim 4, wherein:
said track is part of a rear portion that extends downward from the rear end of said platform.

7. A system according to claim 6, wherein:
said support portion further comprises a truss that extends at an angle between said rear portion and said platform.

8. A system according to claim 1, wherein:
said support portion of said second part comprises at least one hook.

9. A system according to claim 8, wherein:
said support portion of said second part comprises two hooks.

10. A system according to claim 8, wherein:
said track is part of a head portion.

11. A system according to claim 10, wherein:
said at least one hook extends from said head portion.

12. A system according to claim 1, further comprising:
means for maintaining positioning of said plate inside said slot during use.

13. A system according to claim 12, wherein:
said means comprises a magnet of said second part.

14. A system according to claim 12, wherein:
said means comprises interlocking detent elements.

15. A kit for securing articles to a wall or other support structure, the kit comprising:
at least one first part comprising an elongate hand-holdable plate with a rear portion extending rearward from said plate, said rear portion having a helical threaded interface for screwing into the wall or other support structure by hand manipulation of said plate;
a plurality of second parts each comprising a support portion and a rear-facing track, said support portion for mechanically supporting at least one article during use, and said track having a slot for receiving said plate of said first part and a narrow opening extending lengthwise along said slot to allow passage of said rear portion of said first part therethrough during use.

16. A kit according to claim 15, wherein:
said support portion of at least one second part comprises a platform for supporting a shelf.

17. A kit according to claim 15, wherein:
said support portion of at least one second part comprises at least one hook.

18. A kit according to claim 15, wherein:
said support portion of at least one second part comprises two hooks.

19. A method for securing an article on a wall or other support structure, the method comprising:
providing a first part comprising an elongate hand-holdable plate with a rear portion extending rearward from said plate, said rear portion having a helical threaded interface for screwing into the wall or other support structure;
manipulating said plate by hand to screw said threaded interface of said first part into the wall or other support structure;
providing a second part comprising a support portion and a rear-facing track, said support portion for mechanically supporting at least one article during use, and said track having a slot for receiving said plate of said first part and a narrow opening extending lengthwise along said slot to allow passage of said rear portion of said first part therethrough during use; and
sliding said plate of said first part into said slot of said second part, wherein said plate acts as an anchor to secure said second part to the wall or other support structure.

20. A method according to claim 19, wherein:
said support portion of said second part comprises a platform for supporting a shelf or at least one hook.

21. A device for securing an article to a wall or other support structure, the device comprising:
an elongate hand-holdable body;
a rear portion extending rearward from said body, said rear portion having a helical threaded interface for screwing into the wall or other support structure by hand manipulation of said body; and
a support portion extending from said body, said support portion for mechanically supporting at least one article during use.

22. A device according to claim 21, wherein:
said support portion comprises at least one hook.
